(19) United States
(12) Patent Application Publication
(10) Pub. No.: US 2014/0348436 A1
(43) Pub. Date: Nov. 27, 2014

(54) OPERATION METHOD OF IMAGE CODEC CIRCUIT, METHOD OF ENCODING IMAGE DATA AND METHOD OF DECODING IMAGE DATA

(71) Applicants: JungYeop Yang, Seoul (KR); Nyeong-Kyu Kwon, Daejeon (KR)

(72) Inventors: JungYeop Yang, Seoul (KR); Nyeong-Kyu Kwon, Daejeon (KR)

(21) Appl. No.: 14/285,055

(22) Filed: May 22, 2014

(30) Foreign Application Priority Data
May 27, 2013 (KR) 10-2013-0059852

(51) Int. Cl. G06T 9/00

(52) U.S. Cl. CPC G06T 9/00
USPC 382/233; 382/239

(57) ABSTRACT

The inventive concept relates to an encoding method of encoding image data of a frame including a plurality of image blocks. The encoding method includes selecting a first image block as the main image block of a first window, selecting a first window having to perform a plurality of loop filtering schemes on image data of the selected window. The loop filtering schemes includes a deblocking filtering, a sample adaptive offset filtering, and an adaptive loop filtering. The perimeter of the selected first window does not coincide with the perimeter of the first image block.

### CROSS-REFERENCE TO RELATED APPLICATIONS

This application claims priority under 35 U.S.C. 119 to Korean Patent Application No. 10-2013-0059852 filed on May 27, 2013, the disclosure of which is incorporated by reference herein in its entirety.

### BACKGROUND

1. Technical Field

The inventive concept herein relates to electronic devices that process image data, and more particularly, to a method of operating an image codec circuit, a method of encoding image data and a method of decoding image data.

2. Discussion of the Related Art

An image sensor such as a charge coupled device (CCD), a CMOS image sensor (CIS), etc. captures an image to output image data. As the manufacturing technology of image sensors progresses to produce higher resolution and higher quality images, the amount of image data being captured by image sensors is increasing. An increase in the amount of image data makes storage and transmission of image data more difficult.

To suppress an increase in the amount of image data, various methods of compressing image data are being studied. If image data is compressed, the amount of stored image data is reduced. Image data compression needs complicated arithmetic operations when shooting or reproducing image data. Accordingly, image data compression generally increases shooting time (e.g., time between frames) or reproducing (display output) time of image data.

### SUMMARY

An aspect of the inventive concept provides an encoding method of encoding image data including a plurality of image blocks in a frame. The encoding method may include selecting a first window having a first image block among the plurality of image blocks as its main image block to perform a deblocking filtering on image data of the selected first window; and performing a sample adaptive offset filtering on image data of the whole first image block. The selected first window overlaps but does not coincide with the first image block.

In some embodiments, when the intensity is greater than a threshold value, the first offset value has a weighting of 1 and the second offset value has a weighting of 0.

In some embodiments, when the intensity is smaller than a threshold value, the first offset value has a weighting of ½ and the second offset value has a weighting of ½.

An aspect of the inventive concept provides a decoding method of decoding image data a plurality of image blocks. The decoding method may include selecting a first window having a first image block among the plurality of image blocks as its main image block to perform a deblocking filtering on image data of the selected first window; and performing a sample adaptive offset filtering on a basis of the selected first window. The selected window overlaps but does not coincide with the first image block.

An aspect of the inventive concept provides an operating method of an image codec circuit encoding and decoding image data. The operation method may include performing a sample adaptive offset measurement on the image data on the basis of a first window; and performing a sample adaptive offset compensation on the data on which the sample adaptive offset measurement is performed on the basis of a second window.

An aspect of the inventive concept provides an image correction method of correcting image data including a plurality of image blocks. The image correction method may include selecting a first image block among the plurality of image blocks; and performing two or more different filterings on the selected first image block. At least one filtering among the two or more different filterings is performed on the basis of a first window, having its major portion within the first image block. The perimeter of the first window does not coincide with perimeter of the first image block

In some embodiments, selecting of each one image block and performing the two or more different filterings are performed on each one of the plurality of image blocks in a pipeline method.

Exemplary embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout. In the figures:

FIG. 1 is a block diagram illustrating an encoding and decoding system in accordance with some exemplary embodiments of the inventive concept;

FIG. 2 is a flow chart illustrating a method of executing a deblocking and a sample adaptive offset filtering according to a first embodiment of the inventive concept;

FIG. 3 is a flow chart illustrating a method of calculating an offset value in further detail;

FIG. 4 is a flow chart illustrating a method of compensating an offset value in further detail;

FIGS. 5 through 18 show an image frame annotated to illustrate a process that a deblocking is executed and a sample adaptive offset filtering is performed according to a first embodiment of the inventive concept;

FIG. 19 is a frame illustrating a first example of windows being used when a deblocking or offset compensation is executed;

FIG. 20 is a frame illustrating a second example of windows being used when a deblocking or offset compensation is executed;

FIG. 21 is a block diagram of a decoding system in accordance with some exemplary embodiments of the inventive concept;

FIG. 22 is a flow chart illustrating a method of executing a deblocking and a sample adaptive offset filtering according to a second embodiment of the inventive concept;

FIG. 23 is a flow chart illustrating a method of executing a deblocking filtering according to some exemplary embodiments of the inventive concept;

FIG. 24 is a flow chart illustrating a method of calculating an offset value according to an exemplary embodiments of the inventive concept;

FIG. 25 is a block diagram illustrating an encoding and decoding system in accordance with some other exemplary embodiments of the inventive concept;

FIG. 26 is a block diagram illustrating a decoding system in accordance with some other exemplary embodiments of the inventive concept;

FIG. 27 is a block diagram illustrating a codec circuit in accordance with a first embodiment of the inventive concept;

FIG. 28 is a block diagram illustrating a codec circuit in accordance with a second embodiment of the inventive concept; and

FIG. 29 is a block diagram illustrating a multimedia device in accordance with some exemplary embodiments of the inventive concept.

### DETAILED DESCRIPTION OF PREFERRED EMBODIMENTS

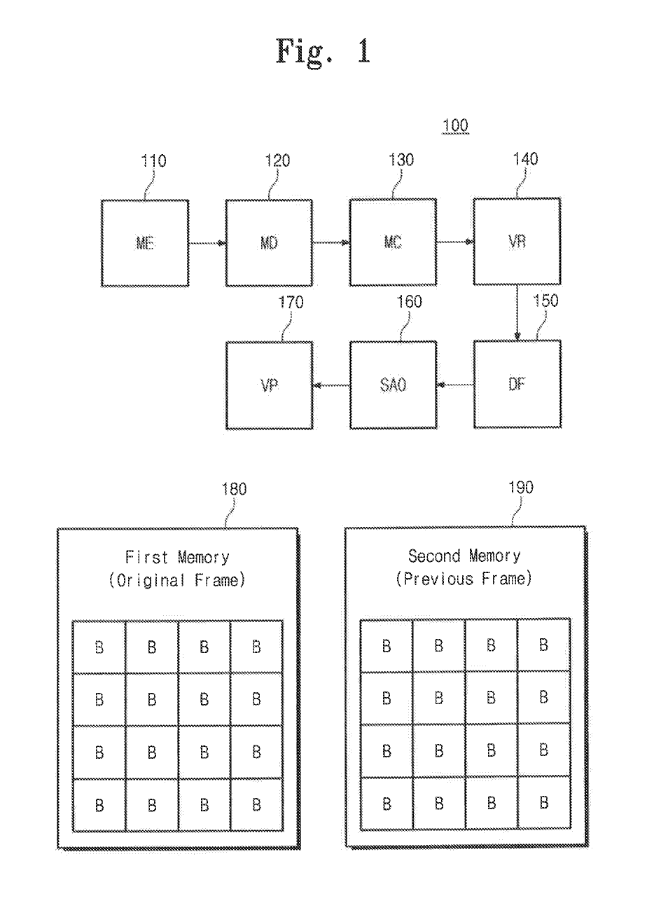

FIG. 1 is a block diagram illustrating an encoding and decoding system in accordance with some exemplary embodiments of the inventive concept. Referring to FIG. 1, the encoding and decoding system 100 includes a motion measurement unit 110, a mode decision unit 120, a motion compensation unit 130, a video reconstruction unit 140, a deblocking filter unit 150, a sample adaptive offset filter unit 160, a video parsing unit 170, a first memory 180, and a second memory 190.

The first memory 180 can store an original frame to be processed by the encoding and decoding system 100. The second memory 190 can store a previous frame which was processed at a different time (e.g., previously) by the encoding and decoding system 100.

Each of the motion measurement unit 110, the mode decision unit 120, the motion compensation unit 130, the video reconstruction unit 140, the deblocking filter unit 150, the sample adaptive offset filter unit 160 and the video parsing unit 170 accesses the first memory 180 or the second memory 190 during the performance of an encoding and a decoding of image data.

In accordance with some exemplary embodiments of the inventive concept, the image data of one frame (or ‘picture’) i is divided into a plurality of image blocks B. The encoding and decoding system 100 sequentially processes the data blocks B (e.g. in a raster scan order). The encoding and decoding system 100 can process the data blocks B in a pipeline method. The motion measurement unit 110, the mode decision unit 120, the motion compensation unit 130, the video reconstruction unit 140, the deblocking filter unit 150, the sample adaptive offset filter unit 160 and the video parsing unit 170 can form cascading stages of the pipeline.

Each of the motion measurement unit 110, the mode decision unit 120, the motion compensation unit 130, the video reconstruction unit 140, the deblocking filter unit 150, the sample adaptive offset filter unit 160 and the video parsing unit 170 can process an image block that shall have been processed in the previous stage. An operation that each of the motion measurement unit 110, the mode decision unit 120, the motion compensation unit 130, the video reconstruction unit 140, the deblocking filter unit 150, the sample adaptive offset filter unit 160 and the video parsing unit 170 processes one image block can be performed at one cycle.

A ‘current frame’, a ‘current picture’ and a ‘current image block’ may be the terms mentioned in each stage of the motion measurement unit 110, the mode decision unit 120, the motion compensation unit 130, the video reconstruction unit 140, the deblocking filter unit 150, the sample adaptive offset filter unit 160 and the video parsing unit 170. It is assumed that the terms a frame, a picture and an image block being used together with word ‘current’ as in a ‘current frame’, a ‘current picture’ and a ‘current image block’ include image data upon which an encoding or a decoding step of a previous stage has been performed.

The motion measurement unit 110 compares an image block of an original frame stored in the first memory 180 with image block of a previous frame stored in the second memory 190. According to a comparison result, the motion measurement unit 110 can detect a block which is most similar to an image block of an original frame from a previous frame. The motion measurement unit 110 can generate a motion vector indicating a location relation between an image block of an original frame and a block detected from a previous frame on the basis of a detection result.

The mode decision unit 120 can decide a prediction mode on the basis of a motion vector. The mode decision unit 120 can decide whether to perform an inter prediction or whether to perform an intra prediction according to a similarity between an image block of an original frame and a block of a previous frame which a motion vector indicates. The mode decision unit 120 can decide a prediction mode to be performed in case of an inter prediction or an intra prediction.

The motion compensation unit 130 can perform motion compensation according to a motion vector and a decided prediction mode. When a decided prediction mode indicates an intra prediction, motion compensation can be omitted. When a decided prediction mode indicates an inter prediction, motion compensation can be performed. The motion compensation unit 130 can load an image block of a previous frame which a motion vector indicates. The image block of the previous frame can be output as a current frame of the video reconstruction unit 140.

The video reconstruction unit 140 can perform an intra prediction according to a prediction mode. In the case that a decided prediction mode indicates an inter prediction, the video reconstruction unit 140 may not perform an intra prediction. If an intra prediction is performed, a block most similar to an image block can be detected from a current frame or image data of an original frame. If an intra prediction is performed, the detected block can be used as a current image block.

After an intra prediction is omitted or performed, the video prediction unit 140 can generate a differential block. The differential block can include differential values between a current image block generated through an inter prediction or an intra prediction and an image block of an original frame.

The video reconstruction unit 140 can perform a transform (e.g., a discrete cosine transform) and a quantization on the differential block. The video reconstruction unit 140 can perform an inverse transform or an inverse quantization on data on which a transform and a quantization are performed.

The deblocking filter unit 150 can execute a deblocking. A window on which a deblocking is executed does not coincide with an image block. The deblocking filter unit 150 can select a current image block as a main image block of a window. The main image block of the window is the image block occupying most (e.g., more than 50%) of the window. The main image block of a window may be most of the area included in the window. As an option, the deblocking filter unit 150 can select a window further including portions of other image blocks (e.g., current image blocks) adjacent to the main image block of the window. For example, the adjacent image block corresponding to the selected window is other image blocks which are not the main image block.

The adjacent image blocks may be image blocks processed as the main image block of a window in the deblocking filter unit 150 during a previous cycle. For example, the deblocking filter unit 150 can select an i-th image block as a main image block at an i-th cycle (i is a positive integer) and can select a part of the i-th image block as the i-th window. The deblocking filter 150 can select the i-th image block as an adjacent image block at a j-th cycle (j is a positive integer greater than the i) and can select the other part of the i-th image block as a window. During the last cycle executing a deblocking in a current frame, the deblocking filter unit 150 can select an area including the whole main image block of the last window as the last window.

The deblocking filter unit 150 calculates an offset value of a current image block. The deblocking may be a step selectively performing a low pass filtering on a boundary between current image blocks included in a selected window.

The sample adaptive offset filter unit 160 can calculate an offset value of a current image block. The sample adaptive offset filter unit 160 can compare an original image block with a current image block and calculate differential values between the original image block and the current image block. The sample adaptive offset filter unit 160 calculates the average of the differential values by an offset value. The sample adaptive offset filter unit 160 reflects the calculated offset value to compensate a current image block.

In a sample adaptive offset filtering, an image block of which an offset value is calculated may be different from the window of which an offset value is compensated. The calculation of an offset value can be performed on the basis of data on which a deblocking is executed and data on which a deblocking is not executed. A compensation of an offset value can be performed on the basis of a window that does not coincide with an image block. The phrase “does not coincide with an image block” means that the perimeter of the window does not coincide with the perimeter of the main image block of that window. For example, two sides of the perimeter of the window does not coincide with the perimeter of the main image block of that window. In another example, all four sides of the perimeter of the window does not coincide with the perimeter of the image block of that window. A window on which a compensation of an offset value is performed may coincide with a window on which a deblocking is executed. A compensation of an offset value can be performed on the basis of offset values of two or more image blocks.

The video parsing unit 170 analyzes and codes a current image block. For example, the video parsing unit 170 can perform a context-adaptive variable-length coding (CAVLC) or a context-adaptive binary arithmetic coding (CARAC).

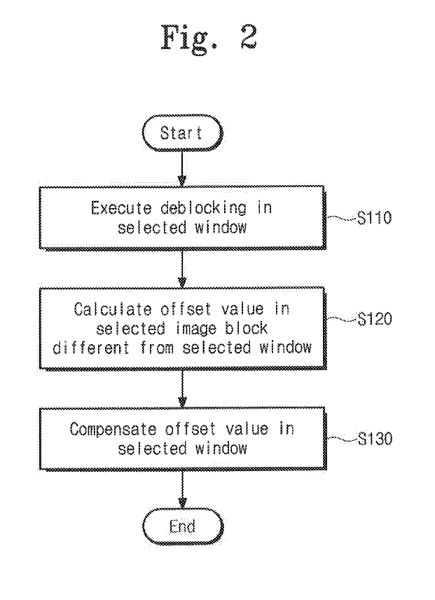

FIG. 2 is a flow chart illustrating a method of executing a deblocking and a sample adaptive offset filtering according to a first embodiment of the inventive concept. Referring to FIGS. 1 and 2, in step S110, a deblocking is executed in a selected window. The selected window can have a current image block as its main image block.

In step S120, an offset value is calculated in selected image block different from the selected window. The selected image block may be a current image block.

In the step S110, the deblocking filter unit 150 selects a window having a current image block processed in the video reconstruction unit 140 as its main image block. In the step S120, the sample adaptive offset filter unit 160 can process the main image block of a window processed in the deblocking filter unit 150 as a current image block. Thus, the window selected in the step S110 and the image block selected in the step S120 overlap.

The image block being selected in the step S120 may include image data on which a deblocking is currently executed and image data on which a deblocking is not currently executed. Image data corresponding to a selected window among image data of the selected image block may be image data on which a deblocking is currently executed. Image data that does not correspond to a selected window among image data of the selected image block may be image data on which a deblocking is not currently executed. In the selected image block, an offset value can be calculated on the basis of the image data on which a deblocking is currently executed and the image data on which a deblocking is not currently executed.

An offset value can be calculated according to the difference between image data of an original image block and image data of a current image block selected by the sample adaptive offset filter unit 160.

In step S130, an offset value is compensated in a selected window. For example, a compensation of an offset value can be performed on image data on which a deblocking is executed in the step S110. The window on which a compensation of an offset value is performed in the step S130 can coincide with the window on which a deblocking is executed in the step S110.

The operations S120 and S130 may be a sample adaptive filtering being performed b the sample adaptive filter unit 160.

According to some exemplary embodiments of the inventive concept, units for performing a deblocking and a sample adaptive offset filtering are differently set. A deblocking is executed by a window unit that does not coincide with an image block. A calculation of an offset value is performed by an image block unit and compensation of an offset value is performed by a window unit being used when a deblocking is executed.

The sample adaptive offset filtering unit 160 compensates an offset value using a window which is a unit of a deblocking (i.e., a deblocking step). Thus, the sample adaptive offset filtering unit 160 can compensate image data on which a deblocking step is executed for an offset value without a delay. The sample adaptive offset filtering unit 160 calculates an offset value on the basis of image data on which a deblocking is executed and image data on which a deblocking is not executed without waiting until all image data of an image block are deblocked. Thus, the sample adaptive offset filtering unit 160 can calculate an offset value without a delay for image data on which a deblocking is executed.

The sample adaptive offset filtering unit 160 can perform calculation and compensation of an offset value without a delay on image data on which a deblocking is executed. Thus, image data can be processed in a pipeline method without a delay in the deblocking filter unit 150 and the sample adaptive offset filter unit 160.

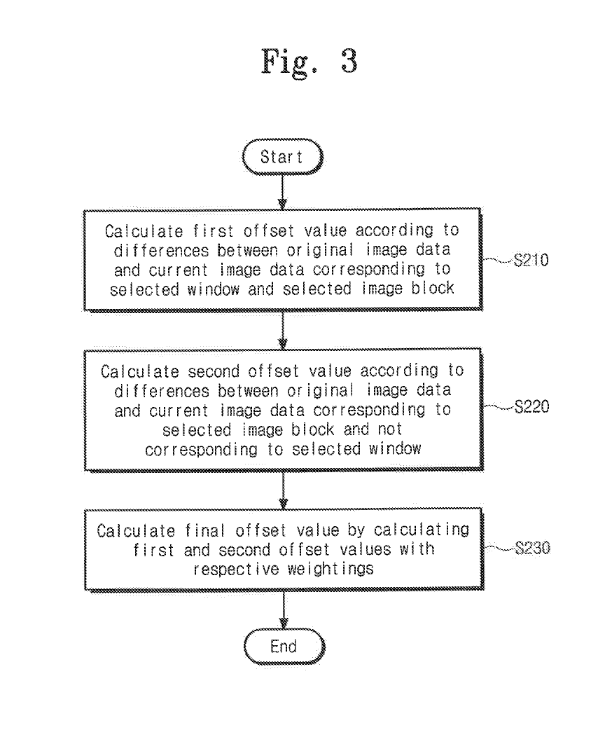

FIG. 3 is a flow chart illustrating a method of calculating an offset value in further detail. Referring to FIGS. 1 and 3, in step S210, a first offset value is calculated according to the difference between original image data and current image data corresponding to a selected window and a selected image block.

For example, image data that belongs to the selected window and the selected image block in common among the original image data can be selected as first image data. Image data that belongs to the selected window among image data of the selected image block can be selected as second image data. The first offset value can be calculated according to the difference between the first and second image data. Since the second image data belongs to the selected window, the first offset value can be an offset value based on image data on which a deblocking is executed.

In step S220, a second offset value is calculated according to the difference between original image data and current image data corresponding to the selected image block and not corresponding to the selected window.

Image data that belongs to the selected image block and does not belong to the selected image block among the original image data can be third image data. Image data that does not belong to the selected window among image data of the selected image block can be fourth image data. A second offset value can be calculated according to the difference between the third image data and the fourth image data. Since the fourth image data does not belong to the selected window, the second offset value can be an offset value based on image data on which a deblocking is not executed.

In step S230, a final offset value is calculated by calculating the first and second offset values with respective weightings (e.g., by performing weighted calculation of the first and second offset values).

An encoding method according to some exemplary embodiments of the inventive concept calculates first and second offset values on the basis of image data on which a deblocking is executed and image data on which a deblocking is not executed. The first and second offset values are calculated using different weightings. Thus, degradation of image quality caused by calculating an offset value using image data on which a deblocking is not executed is minimized.

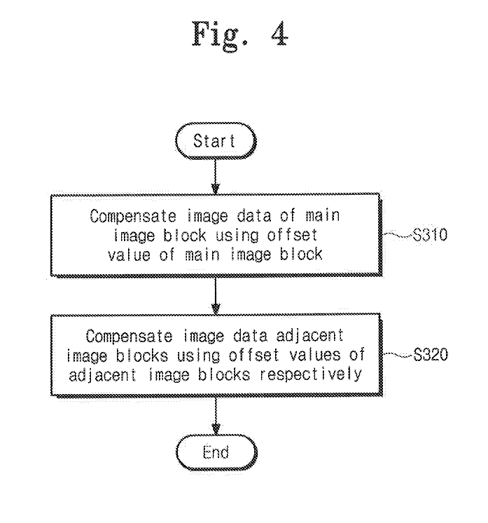

FIG. 4 is a flow chart illustrating a method of compensating an offset value in further detail. Referring to FIGS. 1 and 4, in step S310, image data of the main image block of a window is compensated using an offset value of the main image block.

In step S320, image data of adjacent image blocks are compensated respectively using offset values of the adjacent image blocks.

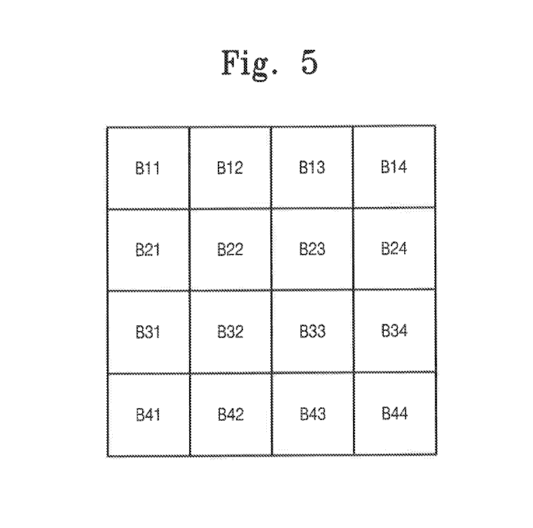

FIGS. 5 through 18 show an image frame annotated to illustrate a process that a deblocking is executed and a sample adaptive offset filtering is performed according to a first embodiment of the inventive concept. As an example, operations of the deblocking filter unit 150 and the sample adaptive offset filter unit 160 are described on the basis of a pipeline structure.

Referring to FIGS. 1 and 5, image data of the frame includes a plurality of image blocks B11˜B44.

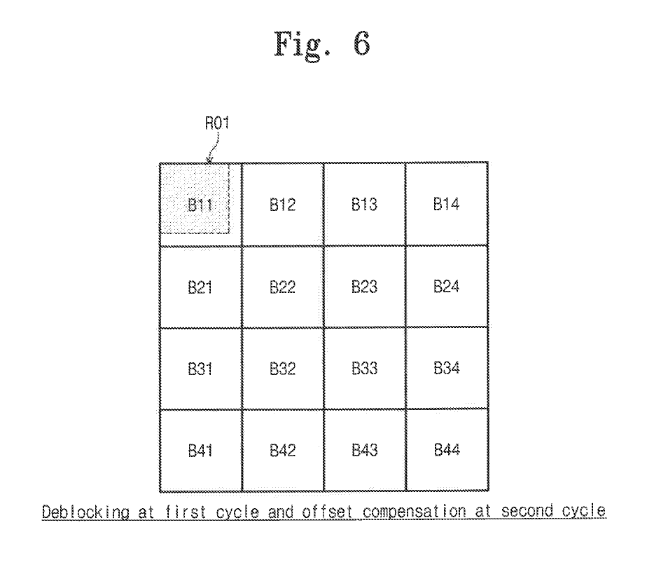

FIG. 6 illustrates an example that the deblocking filter unit 150 and the sample adaptive offset filter unit 160 perform an operation of a first cycle.

Referring to FIGS. 1 and 5, in the first cycle, a current image block of the deblocking filter unit 150 may be an image block B11. The deblocking filter unit 150 can select the image block B11 as the main image block of a window to execute a deblocking. The deblocking filter unit 150 can select the rest part of the main image block B11 except an area adjacent to a boundary of image blocks (e.g., B12 and B21) on which a deblocking will be executed later as a first window R01. The first window R01 selected by the deblocking filter unit 150 does not include a portion of the lower part and the right part of the received image block B11. The selected first window R01 is illustrated in the form of a square filled with dots.

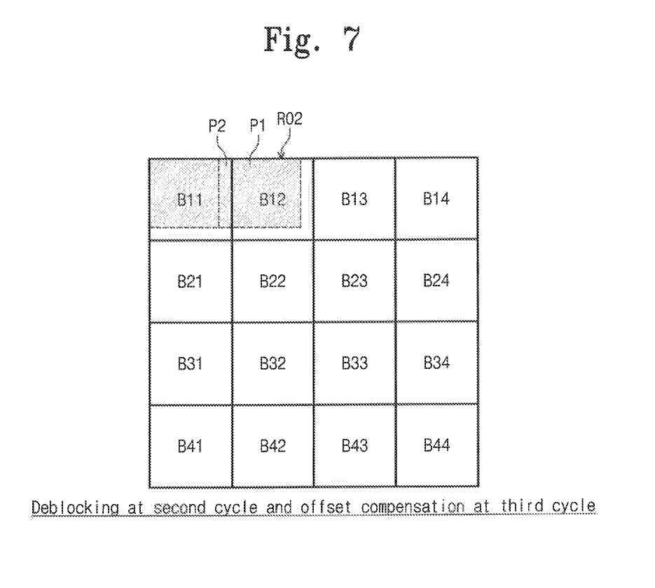

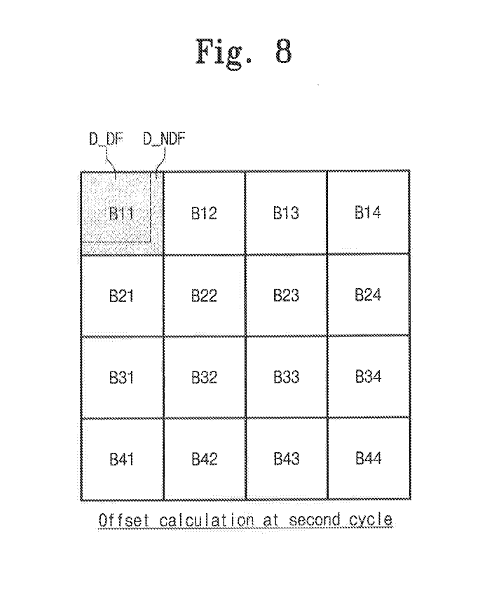

FIGS. 7 and 8 illustrate an example that the deblocking filter unit 150 and the sample adaptive offset filter unit 160 of a pipe line structure perform an operation of a second cycle.

Referring to FIGS. 1 and 7, during the second cycle, a current image block of the deblocking filter unit 150 may be the image block B12. The deblocking filter unit 150 can select the image block B12 as the main image block of window to execute a deblocking. The deblocking filter unit 150 can select the rest (part P1) of the main image block B12 except an area adjacent to a boundary of image blocks (e.g., B13 and B22) on which a deblocking will be executed later as a second window R02. The deblocking filter unit 150 can further select a part P2 on which a deblocking is not executed among the image block B11 on which a deblocking is executed and which is adjacent to the main image block B12 as the second window R02.

The second window R02 selected by the deblocking filter unit 150 does not include a portion of the lower part and the right part of the received image block B12. The second window R02 selected by the deblocking filter unit 150 may include the part P2 of the adjacent image block B11. For example, the deblocking filter unit 150 can select the part P1 between a part on which a deblocking is executed in the adjacent image block B11 and the part P2 selected as a window in the received image block B12 as a window.

Referring to FIGS. 1 and 8, during the second cycle, the sample adaptive offset filter unit 160 can use the image block B11 on which a deblocking is executed during a previous cycle (the first cycle) as a current image block. The sample adaptive offset filter unit 160 can calculate the image block B11 to calculate an offset value. Image data of the image block B11 includes a part D_DF on which a deblocking is executed and a part D_NDF on which a deblocking is not executed. The sample adaptive offset filter unit 160 can calculate a first offset value on the basis of the part D_DF on which a deblocking is executed. The first offset value can be calculated according to a mathematical formula 1.

$$OFF 1 = \frac{{\sum }_{n = 0}^{N - 1} ( OPn - CPn )}{N} \qquad [ mathematical formula 1 ]$$

Herein, OFF1 is the first offset value, N is the number of pixels of the area D_DF on which a deblocking is executed, OPn is a value (for example, image data of an original image block) of each pixel corresponding to the area D_DF on which a deblocking is executed among an original image block and CPn is a value (for example, image data of the received image block B 11) of each pixel of the area D_DF on which a deblocking is executed among the received image block B11

The sample adaptive offset filter unit 160 can calculate a second offset value on the basis of the part D_NDF on which a deblocking is not executed. The second offset value can be calculated according to a mathematical formula 2.

$$OFF 2 = \frac{{\sum }_{m = 0}^{M - 1} ( OPm - CPm )}{M} \qquad [ mathematical formula 2 ]$$

Herein, OFF2 is the second offset value, M is the number of pixels of the area D_NDF on which a deblocking is not executed, OPm is a value (for example, image data of an original image block) of each pixel corresponding to the area D_NDF on which a deblocking is not performed among an original image block and CPm is a value (for example, image data of the received image block B11) of each pixel of the area D_NDF on which a deblocking is not performed among the received image block B11.

The sample adaptive offset filter unit 160 can calculate a final offset value on the basis of the first offset value and the second offset value. The final offset value can be calculated according to a mathematical formula 3.

FOFF=w0×OFF1+w1×OFF2+c [mathematical formula 3]

Herein, FOFF is the final offset value, w0 is a first weighting being added to the first offset value OFF1, w1 is a second weighting being added to the second offset value OFF2 and c is a correction constant.

The first and second weightings can be variously set like a table 1.

TABLE 1

| | | Second | |
|---|---|---|---|
| | First weighting (w0) | weighting (w1) | Correction constant (c) |
| Example 1 | 1 | 0 | 0 |
| Example 2 | ½ | ½ | 0 |
| Example 3 | ½ | ½ | −1 |
| Example 4 | N/(N + M) | M/(N + M) | 0 |
| Example 5 | DF < TH, ½ | DF < TH, ½ | 0 |
| | DF >= TH, 1 | DF >= TH, 0 | |

In the example 1, the first weighting w0 can be set to 1 and the second weighting can be set to 0. Thus, the second offset value OFF2 calculated from the area D_NDF on which a deblocking is not performed can be ignored. At this time, the second offset value OFF2 may not be calculated.

In the example 2, the first weighting w0 can be set to ½ and the second weighting w1 can be set to ½. Thus, the first offset value OFF1 calculated from the area D_DF on which a deblocking is executed and the second offset value OFF2 calculated from the area D_NDF on which a deblocking is not executed can be applied to the final offset value at the same rate.

In the example 3, a value that a correction constant (c) of −1 is further calculated on the final offset value according to the example 2 can be calculated as the final offset value FOFF.

In the example 4, the first weighting w0 and the second weighting w1 can be determined by a ratio of the area D_DF on which a deblocking is executed to the area D_NDF on which a deblocking is not executed. The first weighting w0 can be determined by a ratio of the number of pixels of the area D_DF on which a deblocking is executed to the number of pixels of the selected image block. The second weighting w1 can be determined by a ratio of the area D_NDF on which a deblocking is not executed to the number of pixels of the selected image block.

In the example 5, the first weighting w0 and the second weighting w1 can be differently set by intensity that a deblocking is executed. When a deblocking intensity factor DF is greater than a threshold value TH, the first weighting w0 can be set to ½ and the second weighting w1 can be set to ½. When a deblocking intensity factor DF is smaller than a threshold value TH, the first weighting w0 can be set to 1 and the second weighting w1 can be set to 0.

The deblocking intensity factor DF represents intensity that a deblocking is executed. The deblocking intensity factor DF can include information about how many high frequency components are removed when a deblocking is executed. As the deblocking intensity factor DF increases, more high frequency components can be removed when a deblocking is executed. As the deblocking intensity factor DF decreases, less high frequency components can be removed when a deblocking is executed.

If a deblocking is weakly executed enough to make the deblocking intensity factor DF smaller than the threshold value TH, the second offset value OFF2 corresponding to an area in which a deblocking is not executed can be reflected in the final offset value FOFF. If a deblocking is strongly executed enough to make the deblocking intensity factor DF greater than the threshold value TH, the second offset value OFF2 corresponding to an area in which a deblocking is not executed may not be reflected in the final offset value FOFF.

The deblocking intensity factor DF may be the maximum change value of image data being changed by a deblocking. The deblocking intensity factor DF may be the average change value of image data being changed by a deblocking. The sample adaptive offset filter unit 160 can set weightings w0 and w1 according to a result of a deblocking.

The deblocking intensity factor DF can be determined according to a quantization parameter QP being used when the video reconstruction unit 140 performs a quantization. As the video reconstruction unit 140 strongly performs a quantization and a quantization is performed using fewer samples, the deblocking intensity factor DF can be increased. As the video reconstruction unit 140 weakly performs a quantization and a quantization is performed using more samples, the deblocking intensity factor DF can be decreased. The sample adaptive offset filter unit 160 can set weightings w0 and w 1 according to a quantization parameter QP.

The method of setting the weightings w0 and w1 can be variously applied through combinations of at least two examples among the examples 1˜5. The method of setting weightings w0 and w1 is not limited to the examples 1˜5 described above.

During the second cycle, after the final offset value OFF is calculated, compensation can be performed using the final offset value FOFF. The compensation using the final offset value FOFF can be performed on image data on which a deblocking is executed. The compensation can be performed on image data corresponding to a window selected when a deblocking is executed. As illustrated in FIG. 6, the sample adaptive offset filter unit 160 can select the first window R01 in the image block B11 of which the final offset value FOFF is calculated. The selected first window R01 can be identical to a window selected when a deblocking is executed in the first image block B11. The sample adaptive offset filter unit 160 can perform offset compensation in the selected first window R01. For example, the sample adaptive offset filter unit 160 can add the final offset value FOFF to image data (e.g., image data of each pixel) of the selected first window R01.

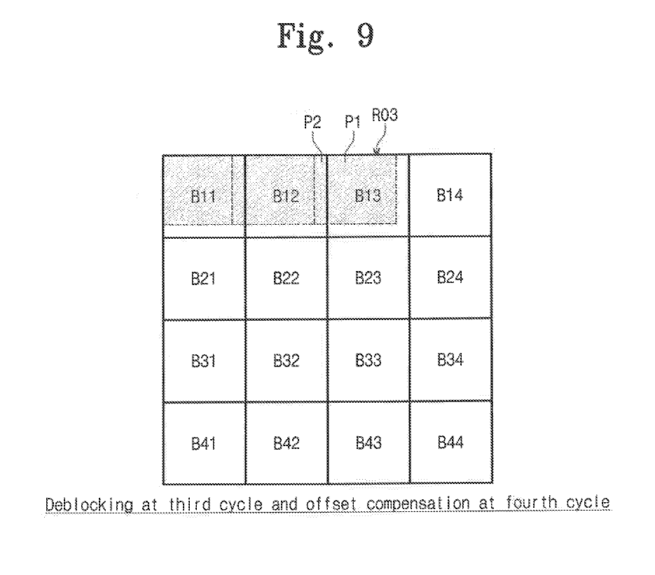

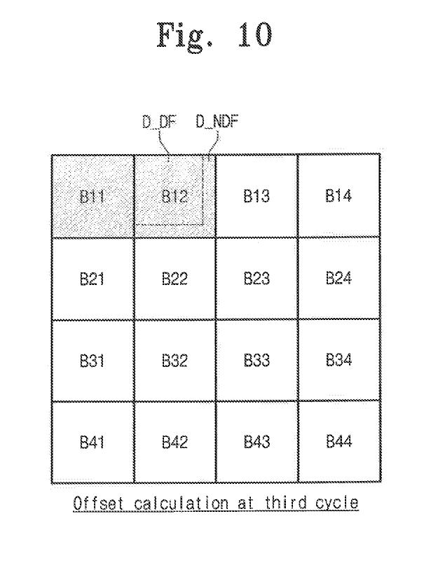

FIGS. 9 and 10 illustrate an example that the deblocking filter unit 150 and the sample adaptive offset filter unit 160 of a pipeline structure perform an operation of a third cycle.

Referring to FIGS. 1 and 9, during the third cycle, a current image block of the deblocking filter unit 150 may be an image block B13. The deblocking filter unit 150 selects the image block B13 as the main image block of a window to execute a deblocking. The deblocking filter unit 150 can select the rest part P1 of the main image block B13 except an area adjacent to a boundary of image blocks (e.g., B14 and B23) on which a deblocking will be executed later as a third window R03. The deblocking filter unit 150 can further select a part P2 on which a deblocking is not executed among the image block B12 on which a deblocking is executed and which is adjacent to the main image block B13 as the third window R03.

Referring to FIGS. 1 and 10, during the third cycle, the sample adaptive offset filter unit 160 can use the image block B12 on which a deblocking is executed at a pervious cycle (the second cycle) as a current image block. The sample adaptive offset filter unit 160 can select the image block B12 to calculate an offset value. Image data of the image block B12 includes a part D_DF on which a deblocking is executed and a part D_NDF on which a deblocking is not executed. The sample adaptive offset filter unit 160 can calculate a first offset value OFF1 on the basis of the part D_DF on which a deblocking is executed. The sample adaptive offset filter unit 160 can calculate a second offset value OFF2 on the basis of the part D_NDF on which a deblocking is not executed. The sample adaptive offset filter unit 160 can calculate a final offset value FOFF on the basis of the first offset value OFF1 and the second offset value OFF2.

During the third cycle, after the final offset value is calculated, compensation using the final offset value FOFF can be performed. As illustrated in FIG. 7, the sample adaptive offset filter unit 160 can select a second window R02. The selected second window R02 can be identical to a window selected when a deblocking is executed in the second image block B12. The sample adaptive offset filter unit 160 can perform offset compensation in the selected second window R02.

The sample adaptive offset filter unit 160 can perform compensation of the part P1 corresponding to the main image block B12 in the selected second window R02 using the final offset value FOFF of the main image block B12. The sample adaptive offset filter unit 160 can perform offset compensation of the part P2 corresponding to the adjacent image block B11 in the selected second window R02 using the final offset value FOFF of the adjacent image block B 11. The sample adaptive offset filter unit 160 can add the final offset value FOFF to image data (e.g., image data of each pixel) of the selected second window R02.

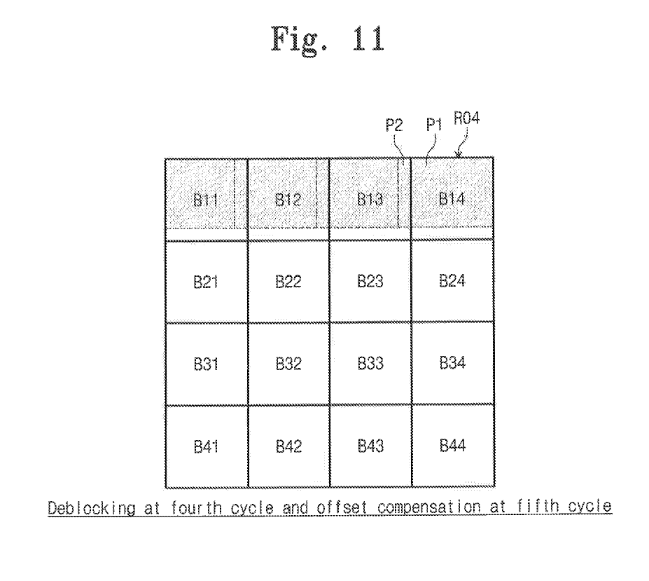

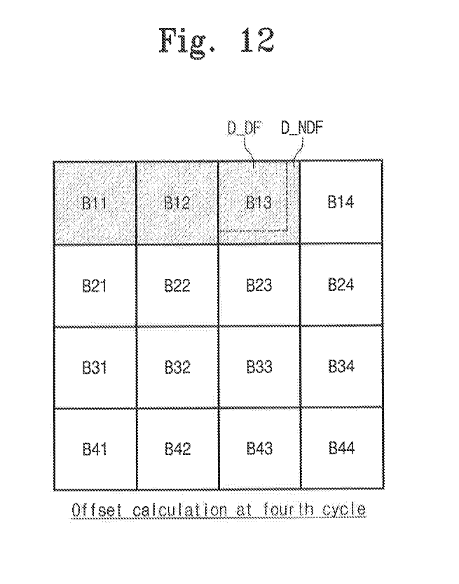

FIGS. 11 and 12 illustrate an example that the deblocking filter unit 150 and the sample adaptive offset filter unit 160 of a pipeline structure perform an operation of a fourth cycle.

Referring to FIGS. 1 and 11, during the fourth cycle, a current image block of the deblocking filter unit 150 may be an image block B14. The deblocking filter unit 150 selects the image block B14 as the main image block of a window to execute a deblocking. The deblocking filter unit 150 can select the most (part P1) of the main image block B14 (excepting an area adjacent to a boundary of image blocks (e.g., B24) on which a deblocking will be executed later) as a main (or major) portion of window R04. The deblocking filter unit 150 can further select a slice (part P2) on which a deblocking is not executed within the image block B13 on which a deblocking is executed and which is adjacent to the main image block B14 as a minor portion of (or as the minor portion of) the window R04.

Referring to FIGS. 1 and 12, during the fourth cycle, the sample adaptive offset filter unit 160 can use the image block B13 on which a deblocking is executed at a pervious cycle (the third cycle) as a current image block. The sample adaptive offset filter unit 160 can select the image block B13 to calculate an offset value.

During the fourth cycle, after the offset value is calculated, compensation using the calculated offset value can be performed. As illustrated in FIG. 9, the sample adaptive offset filter unit 160 can select a third window R03. The selected third window R03 can be identical to a window selected when a deblocking is executed in the third image block B13. The sample adaptive offset filter unit 160 can perform offset compensation in the selected third window R03.

The sample adaptive offset filter unit 160 can perform compensation of the part P1 corresponding to the main image block B13 in the selected third window R03 using an offset value of the main image block B13. The sample adaptive offset filter unit 160 can perform offset compensation of the part P2 corresponding to the adjacent image block B12 in the selected third window R03 using the offset value of the adjacent image block B12.

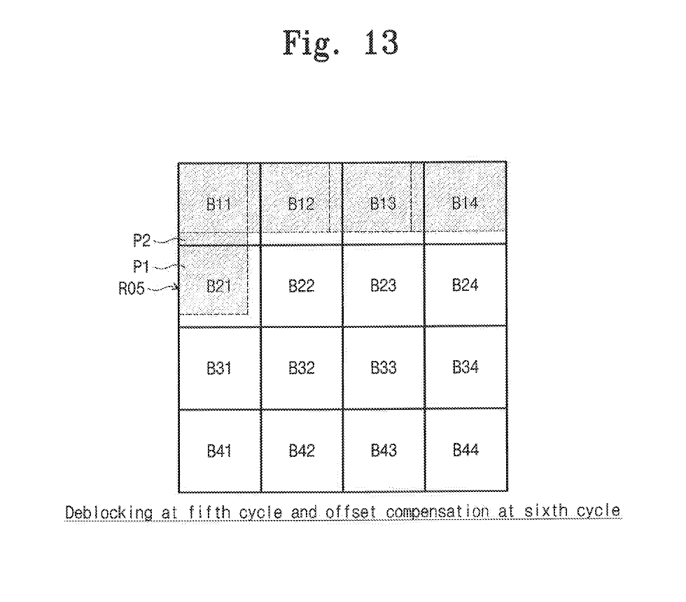

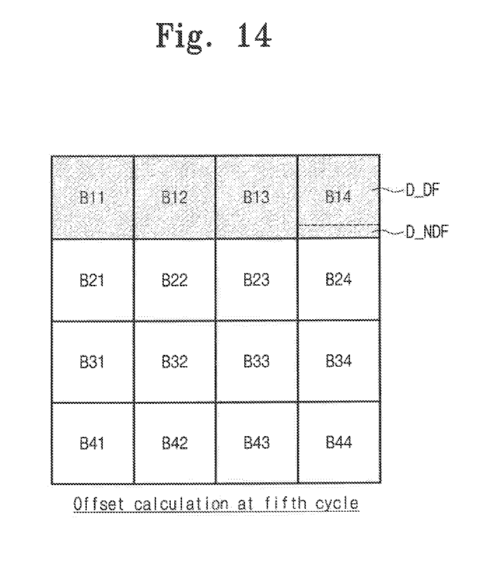

FIGS. 13 and 14 illustrate an example that the deblocking filter unit 150 and the sample adaptive offset filter unit 160 of a pipeline structure perform an operation of a fifth cycle.

Referring to FIGS. 1 and 13, during the fifth cycle, a current image block of the deblocking filter unit 150 may be an image block B21. The deblocking filter unit 150 selects the image block B21 as the main image block of a window to execute a deblocking. The deblocking filter unit 150 can select the rest part P1 of the main image block B21 except an area adjacent to a boundary of image blocks (e.g., B22 and B21) on which a deblocking will be executed later as a fifth window R05. The deblocking filter unit 150 can further select a part P2 on which a deblocking is not executed among the image block B11 on which a deblocking is executed and which is adjacent to the main image block B21 as the fifth window R05.

Referring to FIGS. 1 and 14, during the fifth cycle, the sample adaptive offset filter unit 160 can use the image block B14 on which a deblocking is executed at a pervious cycle (the fourth cycle) as a current image block. The sample adaptive offset filter unit 160 can select the image block B14 to calculate an offset value.

During the fifth cycle, after an offset value is calculated, compensation using the calculated offset value can be performed. As illustrated in FIG. 11, the sample adaptive offset filter unit 160 can select a window R04. The selected window R04 can be identical to a window selected when a deblocking is executed in the fourth image block B14. The sample adaptive offset filter unit 160 can perform offset compensation in the selected third window R03.

The sample adaptive offset filter unit 160 can perform compensation of the part P1 that belongs to the main image block B14 in the selected window R04 using an offset value of the main image block B14. The sample adaptive offset filter unit 160 can perform offset compensation of the part P2 that belongs to the adjacent image block B13 in the selected window R04 using the offset value of the adjacent image block B13.

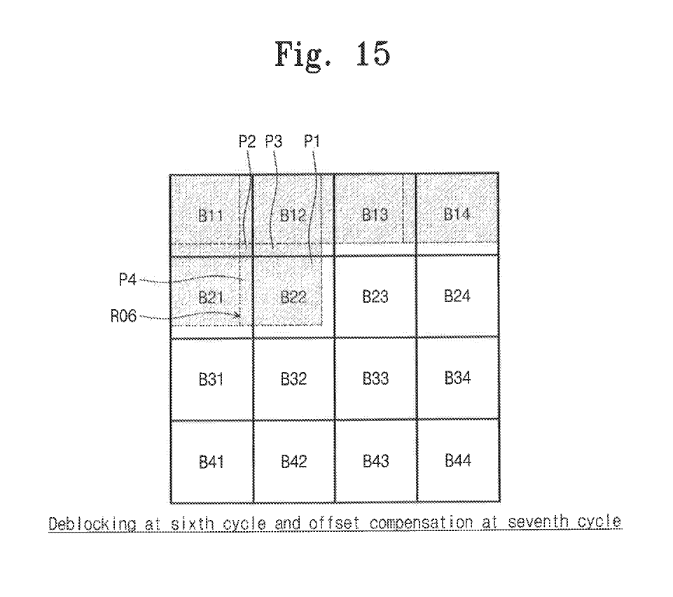

FIGS. 15 and 16 illustrate an example that the deblocking filter unit 150 and the sample adaptive offset filter unit 160 of a pipeline structure perform an operation of a sixth cycle.

Referring to FIGS. 1 and 15, during the sixth cycle, a current image block of the deblocking filter unit 150 may be an image block B22. The deblocking filter unit 150 selects the image block B22 as the main image block of a window to execute a deblocking. The deblocking filter unit 150 can select the rest part P1 of the main image block B22 except an area adjacent to a boundary of image blocks (e.g., B 11, B12 and B21) on which a deblocking will be executed later as a sixth window R06. The deblocking filter unit 150 can further select parts P2, P3 and P4 on which a deblocking is not executed among the image blocks B11, B12 and B21 on which a deblocking is executed and which is adjacent to the main image block B22 as the sixth window R06.

Referring to FIGS. 1 and 16, during the sixth cycle, the sample adaptive offset filter unit 160 can use the image block B21 on which a deblocking is executed at a pervious cycle (the fifth cycle) as a current image block. The sample adaptive offset filter unit 160 can select the image block B21 to calculate an offset value.

During the sixth cycle, after an offset value is calculated, compensation using the calculated offset value can be performed. As illustrated in FIG. 13, the sample adaptive offset filter unit 160 can select a fifth window R05. The selected fifth window R05 can be identical to a window selected when a deblocking is executed in the fifth image block B21.

The sample adaptive offset filter unit 160 can perform offset compensation of the part P1 corresponding to the main image block B21 in the selected fifth window R05 using an offset value of the main image block B21. The sample adaptive offset filter unit 160 can perform offset compensation of the part P2 corresponding to the adjacent image block B11 in the selected fifth window R05 using the offset value of the adjacent image block B11.

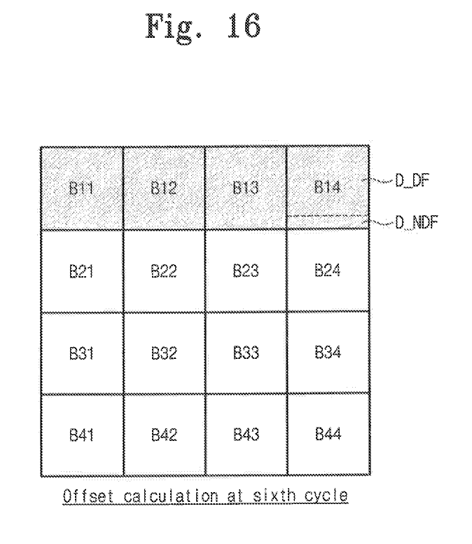

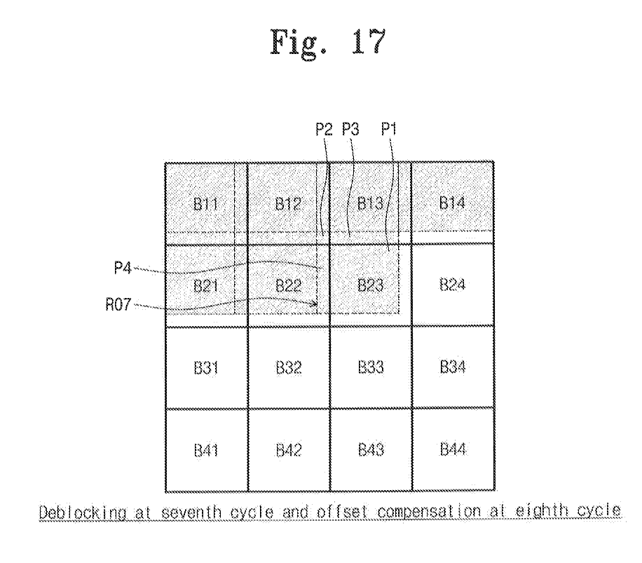

FIGS. 17 and 18 illustrate an example that the deblocking filter unit 150 and the sample adaptive offset filter unit 160 of a pipeline structure perform an operation of a seventh cycle.

Referring to FIGS. 1 and 17, during the seventh cycle, a current image block of the deblocking filter unit 150 may be an image block B23. The deblocking filter unit 150 selects the image block B23 as the main image block of a window to execute a deblocking. The deblocking filter unit 150 can select the rest part P1 of the main image block B23 except an area adjacent to a boundary of image blocks (e.g., B33 and B24) on which a deblocking will be executed later as a window R07. The deblocking filter unit 150 can further select parts P2, P3 and P4 on which a deblocking is not executed among the image blocks B12, B13 and B22 on which a deblocking is executed and which is adjacent to the main image block B23 as the window R07.

Referring to FIGS. 1 and 18, during the seventh cycle, the sample adaptive offset filter unit 160 can use the image block B22 on which a deblocking is executed at a pervious cycle (the sixth cycle) as a current image block. The sample adaptive offset filter unit 160 can select the image block B22 to calculate an offset value.

During the seventh cycle, after an offset value is calculated, compensation using the calculated offset value can be performed. As illustrated in FIG. 15, the sample adaptive offset filter unit 160 can select a sixth window R06. The selected sixth window R06 can be identical to a window selected when a deblocking is executed in the sixth image block B22.

The sample adaptive offset filter unit 160 can perform compensation of the part P1 corresponding to the main image block B22 in the selected sixth window R06 using an offset value of the main image block B22. The sample adaptive offset filter unit 160 can perform offset compensation of the parts P2, P3 and P4 that belong to the adjacent image blocks B11, B12 and B21 in the selected sixth window R06 using the offset values of the adjacent image blocks B11, B12 and B21.

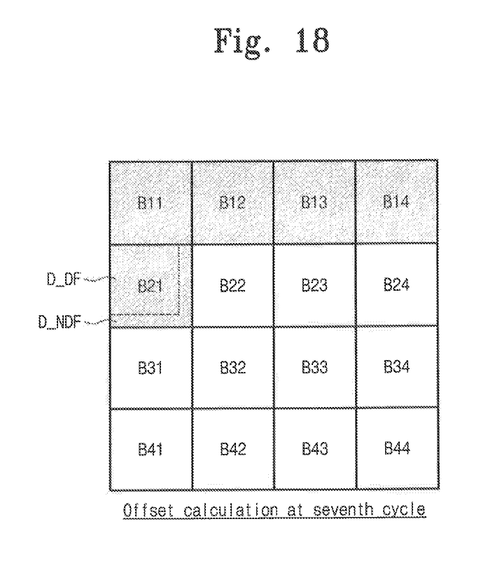

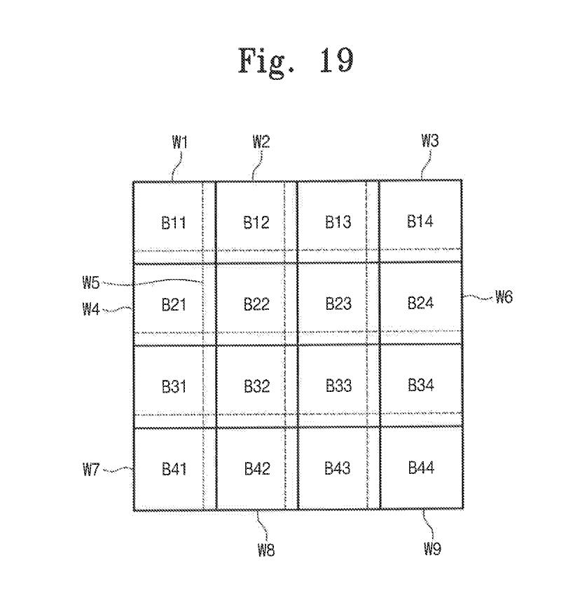

FIG. 19 is a frame illustrating a first example of windows being used when a deblocking or offset compensation is executed. Referring to FIG. 19, when a deblocking or offset compensation is performed, first through ninth windows W1˜W9 can be used.

The first window W1 has a window form used when the image block B11 is its main image block. The first window W1 includes a part of the main image block. The first window W1 does not include the lower part nor the right part of the main image block of the first window W1.

The second window W2 has a window form used when one of the image blocks B12 and B13 is its main image block. The second window W2 includes a part of the main image block of the second window W2 and a part of the image block used as a main image block of a window during a previous cycle. The second window W2 does not include the lower part nor the right part of the main image block of the second window W2. The second window W2 includes a part of an image block located at the left side of the main image block of the second window W2.

The third window W3 has a window form used when the image block B14 is its main image block. The third window W3 includes a part of the main image block of the third window W3 and a part of the image block used as a main image block of a window during a previous cycle. The third window W3 does not include the lower part of the main image block of the third window W3 and does include the right part of the main image block of the third window W3. The third window W3 includes a part of an image block located at the left side of the main image block of the third window W3.

The fourth window W4 has a window form used when one of image blocks B21 and B31 is its main image block. The fourth window W4 includes a part of the main image block of the fourth window W4 and a part of the image block used as a main image block of a window during a previous cycle. The fourth window W4 does not include the lower part nor the right part of the main image block of the fourth window W4. The fourth window W4 includes a part of an image block located above the main image block of the fourth window W4.

The fifth window W5 has a window form used when one of image blocks B22, B23, B32 and B33 is its main image block. The fifth window W5 includes a part of the main image block of the fifth window W5 and a part of three image blocks used as a main image blocks during previous cycles. The fifth window W5 includes a part of image blocks located above, to the left side and above left of the main image block of the fifth window W5.

The sixth window W6 has a form used when one of image blocks B24 and B34 is its main image block. The sixth window W6 includes a part of the main image block of the sixth window W6 and a part of three image blocks used as a main image block of blocks during previous cycles. The sixth window W6 does not include the lower part of the main image block of the sixth window W6 and does include the right part of the main image block of the sixth window W6. The sixth window W6 does include a part of image blocks located above, to the left side and at upper left of the main image block of the sixth window W6.

The seventh window W7 has a form used when an image block B41 is its main image block. The seventh window W7 includes a part of the main image block and a part of the image block used as a main image block during a previous cycle. The seventh window W7 does not include the right part of the main image block of the seventh window W7 and does include the lower part of the main image block of the seventh window W7. The seventh window W7 does include a part of image blocks located above the main image block of the seventh window W7.

The eighth window W8 has a window form used when one of the image blocks B42 and B43 is its main image block. The eighth window W8 includes a part of the main image block of the eighth window W8 and parts of three image blocks used as a main image block during previous cycles. The eighth window W8 does not include the right part of the main image block of the eighth window W8 and does include the lower part of the main image block of the eighth window W8. The eighth window W8 does include a part of image blocks located above, to the left and above left of the main image block of the eighth window W8.

The ninth window W9 has a window form used when an image block B44 is its main image block. The ninth window W9 includes a part of the main image block of the ninth window W9 and parts of three image blocks used as a main image block during previous cycles. The ninth window W9 does include the lower part and the right part of the main image block of the ninth window W9. The ninth window W9 includes a part of image blocks located above, to the left side and above left of the main image block of the ninth window W9.

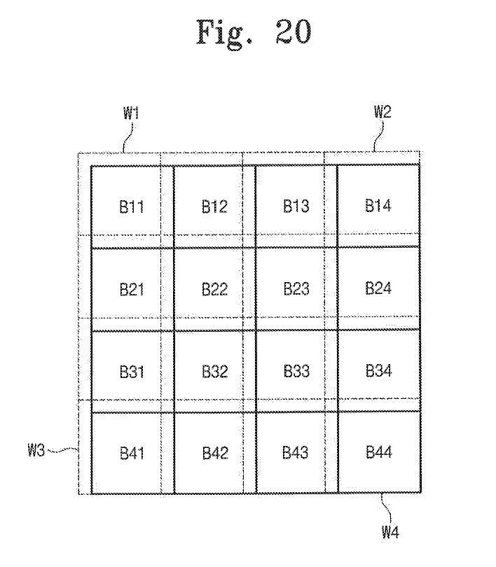

FIG. 20 is a frame illustrating a second example of windows being used when a deblocking or offset compensation is executed. Referring to FIG. 20, when a deblocking or offset compensation is performed, first through fourth windows W1˜W4 can be used.

The first window W1 can have the same size as an image block. The first window W1 has a window form that can be used when one of image blocks B11˜B13, B21˜B23 and B31˜B33 is selected as its main image block. The first window W1 can be positioned at an upper left part of the image block. When the first window W1 is selected, a part in which image data does not exist is not processed.

The second window W2 window form has the same height as the image block and a width wider than the image block. The second window W2 can be used when image blocks B14, B24 and B34 are selected. When the second window W2 is selected, a part in which image data does not exist need not be processed.

The third window W3 has a window form that has the same width as the image block and a height higher than the image block. The third window W3 can be used when image blocks B41, B42 and B43 are selected. When the third window W3 is selected, a part in which image data does not exist need not be processed.

The fourth window W4 has a window form that has a width wider than the image block and a height higher than the image block. The fourth window W4 can be used when an image block B44 is selected.

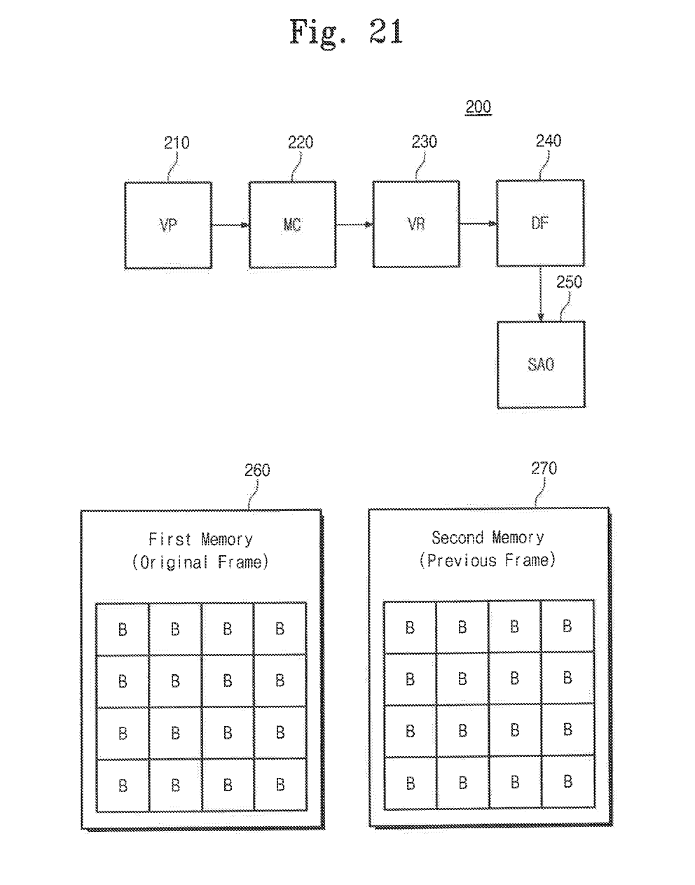

FIG. 21 is a block diagram of a decoding system in accordance with some exemplary embodiments of the inventive concept. Referring to FIG. 21, a decoding system 200 includes a video parsing unit 210, a motion compensation unit 220, a video reconstruction unit 230, a deblocking filter unit 240, a sample adaptive offset filter unit 250, a first memory 260 and a second memory 270.

The first memory 260 can store an original frame to be processed by the decoding system 200. The original frame may be an encoded frame. An image block of the encoded frame may include a motion vector, conversion information related to the video reconstruction unit 230, a quantization parameter, an offset value and conversion information related to the video parsing unit 210. The second memory 190 can store a previous frame which is already processed by the decoding system 200. An image block of the previous frame may include image data.

Each of the video parsing unit 210, the motion compensation unit 220, the video reconstruction unit 230, the deblocking filter unit 240 and the sample adaptive offset filter unit 250 can access the first memory 260 or the second memory 270 and can perform an encoding and a decoding of the image data.

Image data of one frame in accordance with some exemplary embodiments of the inventive concept can be divided into a plurality of image blocks B. The decoding system 200 can sequentially (e.g., in raster scan order) process the multiple image blocks B. The decoding system 200 can process the multiple image blocks B in a pipeline method. The video parsing unit 210, the motion compensation unit 220, the video reconstruction unit 230, the deblocking filter unit 240 and the sample adaptive offset filter unit 250 can form stages of a pipeline.

Each of the video parsing unit 210, the motion compensation unit 220, the video reconstruction unit 230, the deblocking filter unit 240 and the sample adaptive offset filter unit 250 can process an image block processed in a previous stage. Each of the video parsing unit 210, the motion compensation unit 220, the video reconstruction unit 230, the deblocking filter unit 240 and the sample adaptive offset filter unit 250 can process one image block during one cycle.

In the description that follows, ‘current frame’, ‘current picture’ and ‘current image block’ may be mentioned in each stage of the video parsing unit 210, the motion compensation unit 220, the video reconstruction unit 230, the deblocking filter unit 240 and the sample adaptive offset filter unit 250. It will be assumed that ‘frame’, ‘picture’ and ‘image block’ being used together with the term ‘current’ as in the ‘current frame’, the ‘current picture’ and the ‘current image block’ to refer to image data on which decoding of previous stages is performed.

The video parsing unit 210 can analyze and code a current image block. For example, the video parsing unit 210 can perform context-adaptive variable-length coding (CAVLC) or context-adaptive binary arithmetic coding (CABAC).

The motion compensation unit 220 can detect a motion vector from a current image block. According to the detected motion vector, the motion compensation unit 220 can load an image block of a previous frame stored in the second memory 270. The image block of the previous frame can be output as a current frame. In the case that a current image block corresponds to an intra prediction, motion compensation can be omitted.

The deblocking filter unit 240 can select a window having a current image block as a main image block and can perform a deblocking on the selected window. The sample adaptive offset filter unit 250 can detect an offset value from a current image block and can perform offset compensation according to the detected offset value.

Except that a calculation of an offset value is omitted, the deblocking filter unit 240 and the sample adaptive offset filter unit 250 can operate in the same manner as those described with reference to FIGS. 1 through 20.

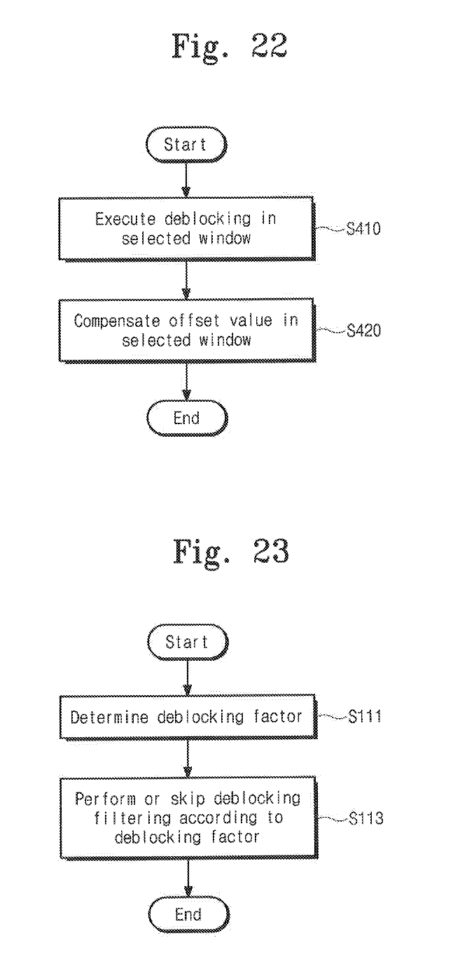

FIG. 22 is a flow chart illustrating a method of executing a deblocking and a sample adaptive offset filtering according to a second embodiment of the inventive concept. Referring to FIGS. 1 and 22, in step S410, a deblocking is executed in a selected window. The selected window can have a current image block as a main image block.

In step S420, an offset value is compensated in the selected window. The window on which compensation of an offset value is performed in the step S420 can be identical to the window on which a deblocking is executed in the step S110.

FIG. 23 is a flow chart illustrating a method of executing a deblocking filtering according to some exemplary embodiments of the inventive concept. Referring to FIG. 23, in step S111, a deblocking intensity factor DF is determined. A deblocking intensity factor DF can be determined depending on whether two or more image blocks are included in a selected window, the included image blocks correspond to an inter prediction or an intra prediction, or motion information (e.g., motion vector) of image blocks included in the selected window is identical to one another or different from one another.

In step S113, a deblocking filtering is performed or skipped depending on a deblocking intensity factor. In the case that a deblocking intensity factor is determined to be the lowest, a deblocking filtering can be skipped. In the case that only one image block is included in the selected window, a deblocking filtering can be skipped. In the case that a deblocking filtering is performed, the deblocking filtering can be performed using different filters (filters each having a different Q factor) depending on the deblocking intensity factor determined in the step SI 11. As an illustration, in a detailed description, an expression that ‘a deblocking filtering is performed in a selected window’ can be understood that it includes an operation of skipping a deblocking filtering when performing a deblocking filtering in a selected window.

As an illustration, after a window on which a deblocking filtering will be performed is selected, a calculation of a deblocking intensity factor in the step S111 and performance (or skip) of a deblocking filtering in the step S113 can be sequentially performed.

As another illustration, deblocking intensity factors of the step S111 are calculated with respect to a plurality of windows, one window is selected and an operation of performing (skipping) a deblocking filtering of the step S113 in the selected window can be sequentially performed.

When a deblocking is executed, a low band pass filtering can be performed on a boundary between image blocks in the selected window. In a boundary between image blocks, a low band pass filtering can be performed on the predetermined number of pixels with the boundary as the center.

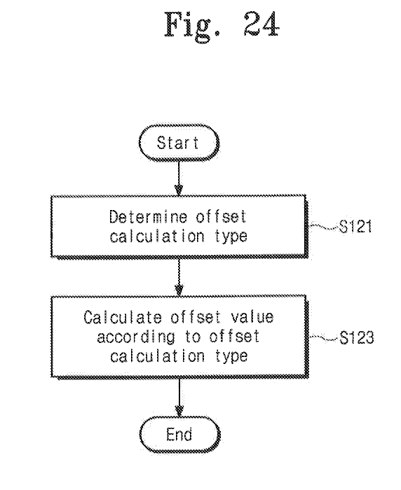

FIG. 24 is a flow chart illustrating a method of calculating an offset value according to an exemplary embodiments of the inventive concept. An operation illustrated in FIG. 24 can be performed before the operation illustrated in FIG. 3 is performed.

Referring to FIG. 24, in step S121, an offset calculation type is determined. Each image block is determined by a prediction (an inter prediction or an intra prediction). Each image block restored by a predicted result includes an error (or distortion). If a prediction result of each image block is different, the amount of errors (or distortions) that exist in each image block can be different from one another. A calculation type of calculating an offset value can be determined differently according to the degree of error (distortion) that exists in each image block. According to the degree of error (or distortion) that exists in each image block, one of various offset calculation types such as 0-degree pattern degree offset, 90-degree pattern degree offset, 135-degree pattern degree offset, 45-degree pattern degree offset, central bands band offset, side bands band offset, etc. According to a rate-distortion optimization method, an offset calculation type can be determined.

In step S123, an offset value is calculated according to an offset calculation type. The step S123 can correspond to the operation of FIG. 3.

As an illustration, after an image block of which an offset value will be calculated is selected, determination of an offset calculation type of the step S121 and calculation of an offset value of the step S123 can be sequentially performed.

As another illustration, offset calculation types of the step S121 are determined with respect to a plurality of image blocks, one image block is selected and an operation of performing (or skipping) a deblocking filtering of the step S123 can be sequentially performed in the selected image block.

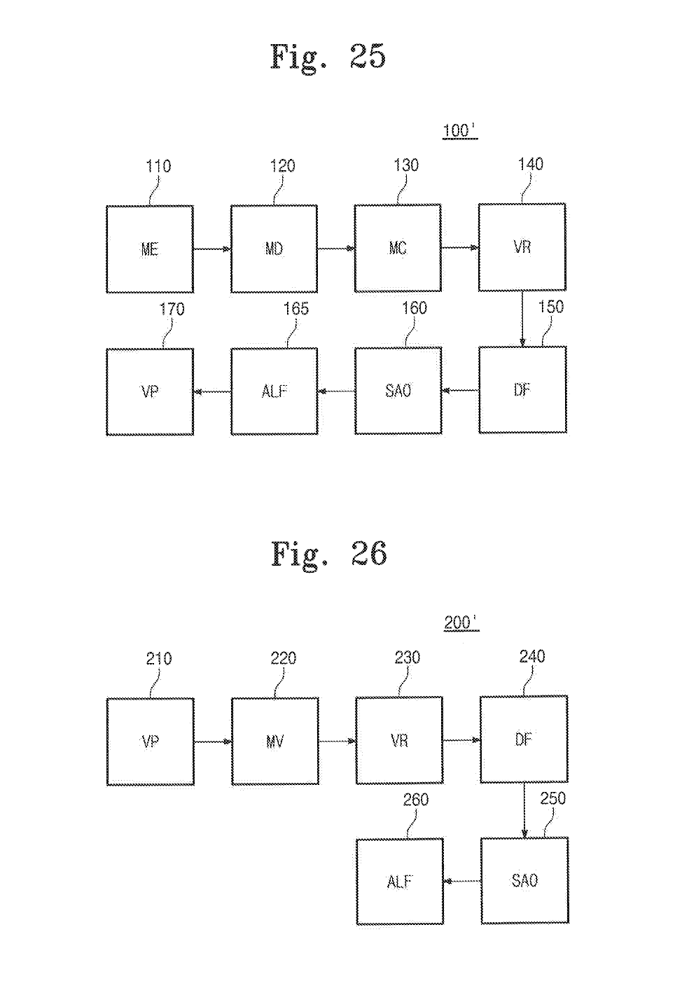

FIG. 25 is a block diagram illustrating an encoding and decoding system in accordance with some exemplary embodiments of the inventive concept. To simplify the explanation, a memory is omitted in FIG. 25.

The encoding and decoding system 100′ further includes an adaptive loop filter 165 as compared with the encoding and decoding system 100 of FIG. 1. The adaptive loop filter unit 165 can perform a filtering between a sample adaptive offset filter unit 160 and a video parsing unit 170. The adaptive loop filter unit 165 can perform a filtering based on a filter.

In common with the sample adaptive offset filter unit 160, the adaptive loop filter unit 165 can calculate a filtering coefficient by an image block unit. The adaptive loop filter unit 165 can calculate a filtering coefficient on the basis of a part on which a deblocking is executed and a part on which a deblocking is not executed. The adaptive loop filter unit 165 can perform a filtering by a window unit. The adaptive loop filter unit 165 can perform a filtering using a filtering coefficient of a main image block or filtering coefficients of image blocks and image blocks adjacent to the main image block.

A process that the adaptive loop filter unit 165 calculates a filtering coefficient can be identical to the process that the sample adaptive offset filtering unit 160 described with reference to FIGS. 5 through 18 calculates an offset value.

FIG. 26 is a block diagram illustrating a decoding system in accordance with some other exemplary embodiments of the inventive concept. To simplify the explanation, a memory is omitted in FIG. 26.

The encoding and decoding system 200′ further includes an adaptive loop filter ALF 260 as compared with the decoding system 200 of FIG. 21. The adaptive loop filter unit 260 can perform a filtering after the sample adaptive offset filter unit 250. The adaptive loop filter unit 260 can perform a filtering based on a Wiener filter.

In common with the sample adaptive offset filter unit 250, the adaptive loop filter unit 260 can perform a filtering using a filtering coefficient of a main image block or filtering coefficients of image blocks and image blocks adjacent to the main image block.

A process that the adaptive loop filter (ALF) unit 260 calculates a filtering coefficient can be identical to the process that the deblocking filter unit 150 described with reference to FIGS. 5 through 18 performs a deblocking filtering.

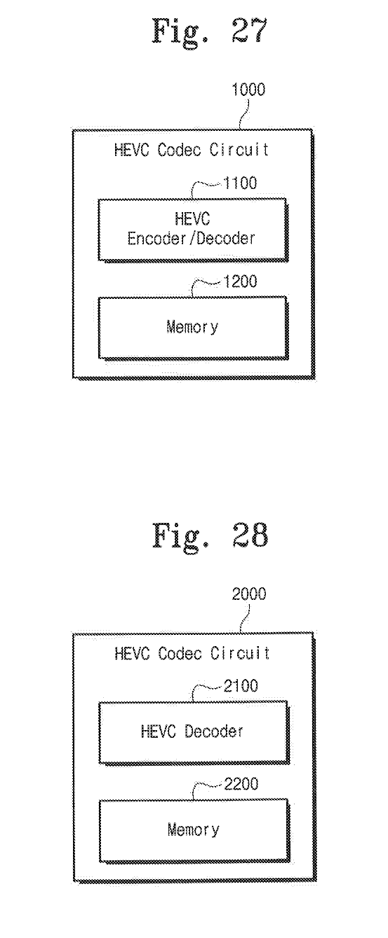

FIG. 27 is a block diagram illustrating a codec circuit in accordance with a first embodiment of the inventive concept. Referring to FIG. 27, a codec circuit 1000 may be a high efficiency video codec (HEVC). The codec circuit 1000 may include an encoder and decoder 1100 and a memory 1200.

The codec circuit 1000 may include the motion measurement unit 110, the mode decision unit 120, the motion compensation unit 130, the video reconstruction unit 140, the deblocking filter unit 150, the sample adaptive offset filter unit 160 and the video parsing unit 170 described with reference to FIG. 1.

The memory 1200 may include the first memory 180 and the second memory 190 described with reference to FIG. 1. The memory 1200 can include one of the first and second memories 180 and 190. One of the first and second memories 180 and 190 can be provided to the outside of the codec circuit 1000.

The codec circuit 1000 can encode and decode image data of an original frame. The codec circuit 1000 can encode and decode a deblocking filtering and a sample adaptive offset filtering without a delay in a pipeline method.

FIG. 28 is a block diagram illustrating a codec circuit in accordance with a second embodiment of the inventive concept. Referring to FIG. 28, a codec circuit 2000 may be a high efficiency video codec (HEVC). The codec circuit 2000 may include an decoder and decoder 2100 and a memory 2200.

The codec circuit 2000 may include the video parsing unit 210, the motion compensation unit 220, the video reconstruction unit 230, the deblocking filter unit 240 and the sample adaptive offset filter unit 250 described with reference to FIG. 21.

The memory 2200 may include the first memory 260 and the second memory 270 described with reference to FIG. 21. The memory 2200 can include one of the first and second memories 260 and 270. One of the first and second memories 260 and 270 can be provided to the outside of the codec circuit 2000.

The codec circuit 2000 can encode and decode image data of an original frame. The codec circuit 2000 can encode and decode a deblocking filtering and a sample adaptive offset filtering without a delay in a pipeline method.

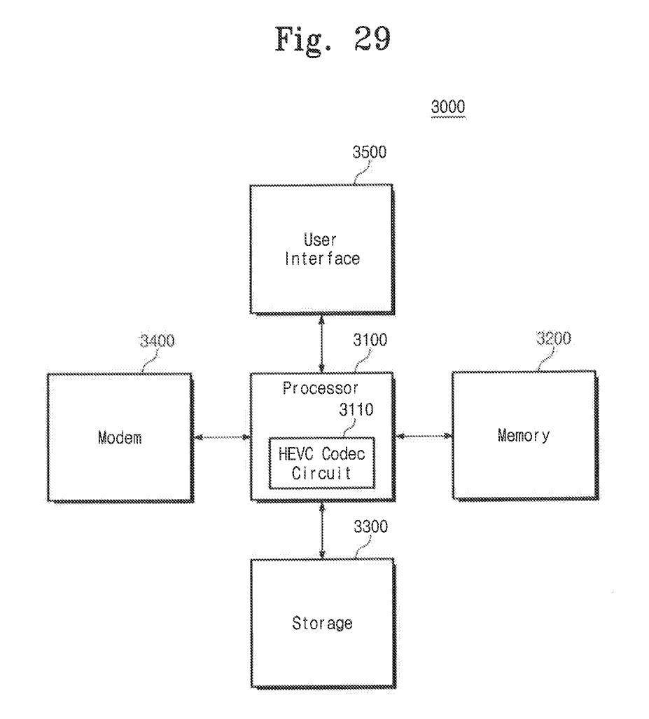

FIG. 29 is a block diagram illustrating a multimedia device in accordance with some exemplary embodiments of the inventive concept. Referring to FIG. 29, a multimedia device 3000 may include a processor 3100, a memory 3200, a storage 3300, a modem 3400 and a user interface 3500.

The processor 3100 can control the whole operation of the multimedia device 3000. The processor 3100 can perform various arithmetic operations and control operations. The processor 3100 may be an application processor or a general-purpose processor. The processor 3100 can be provided as a system-on chip (SOC). The processor 3100 includes a codec circuit 3110.

The codec circuit 3110 may include the codec circuit 1000 described with reference to FIG. 27 and the codec circuit 2000 described with reference to FIG. 28. The codec circuit 3110 can process a deblocking filtering and a sample adaptive offset filtering without a delay in a pipeline method.

The memory 3200 can communicate with the processor 3100. The memory 3200 may be an operating memory (or a main memory) of the processor 3100 or the computing device 3000. The memory 3200 may include a volatile memory such as a static RAM (SRAM), a dynamic RAM (DRAM), a synchronous DRAM (SDRAM), etc. or a nonvolatile memory such as a flash memory, a phase-charge RAM (PRAM), a magnetic RAM (MRAM), a resistive RAM (RRAM), a ferroelectric RAM (FRAM), etc.

The storage 3300 can store data which the computer device 3000 orders stored. The storage 3300 may include a nonvolatile memory such as a hard disk drive (HDD) or a nonvolatile memory such as a flash memory, a phase-charge RAM (PRAM), a magnetic RAM (MRAM), a resistive RAM (RRAM), a ferroelectric RAM (FRAM), etc. The storage 3300 may include a memory system in accordance with some exemplary embodiments of the inventive concept.

The memory 3200 and the storage 3300 can be constituted by the same type of nonvolatile memory. The memory 3200 and the storage 3300 can be constituted by one semiconductor integrated circuit.

The modem 3400 can communicate with an external device according to a control of the processor 3100. The modem 3400 can perform a wire or wireless communication with an external device.

The modem 3400 can perform a communication on the basis of one of various wireless communication methods such as a long term evolution (LTE), WiMax, a global system for mobile communication (GSM), a code division multiple access (CDMA), a Bluetooth, a near field communication (NFC), WiFi, a radio frequency identification (RFID), etc. or various wire communication methods such as a universal serial bus (USB), a serial AT attachment (SATA), a small computer small interface (SCSI), a Firewire, a peripheral component interconnection (PCI), etc.

The user interface 3500 can communicate with a user according to a control of the processor 3100. The user interface 3500 can include user input interfaces such as a keyboard, a keypad, a button, a touch panel, a touch screen, a touch pad, a touch ball, a camera, a mike, a gyroscope sensor, a vibration sensor, etc. The user interface 3500 can include user output interfaces such as a liquid crystal display (LCD), an organic light emitting diode (OLED), a display device, an active matrix OLED (AMOLED) display device, a LED, a speaker, a motor, etc.

The user interface 3500 can include an image shooting device such as an image sensor and an image display device such as a LCD, an AMOLED, etc. The codec circuit 3110 may include the codec circuit 1000 described with reference to FIG. 23. The codec circuit 3110 can encode and decode image data of an original frame. An image encoded by the codec circuit 3110 can be stored in the memory 3200 or the storage 3300. An image encoded by the codec circuit 3110 can be transmitted to an external device through the modem 3400. An image decoded by the codec circuit 3110 can be output through an image display device of the user interface 3500. One of the first memory 180 and the second memory 190 described with reference to FIG. 1 may be the memory 1200 described with reference to FIG. 23 and the other may be the memory 3200.

The user interface 3500 need not include an image shooting device such as an image sensor and may include an image display device such as a LCD, and an AMOLED. At this time, the codec circuit 3110 may include the codec circuit 2000 described with reference to FIG. 24. The codec circuit 3110 can decode data of an original frame. An image decoded by the codec circuit 3110 can be output through an image display device of the user interface 3500. One of the first memory 260 and the second memory 270 described with reference to FIG. 21 is the memory 2200 described with reference to FIG. 28 and the other is the memory 3200 described with reference to FIG. 29.

The codec circuit 3110 can be implemented as a modular circuit design known in the semiconductor industry as an intellectual property (IP), to be embedded in the processor 3100.

According to some exemplary embodiments of the inventive concept, a plurality of loop filtering schemes (for example, a deblocking filtering, a sample adaptive offset filtering and an adaptive loop filtering based on a Wiener filter) is performed in a pipeline method. Thus, an operation method of an image codec circuit that minimizes image degradation and reduces operation time, an encoding method of encoding image data and decoding method of decoding image data are provided.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents. Therefore, the above-disclosed subject matter is to be considered illustrative, and not restrictive.

What is claimed is:

1. An encoding method for encoding image data of a frame including a plurality of image blocks, the method comprising:
selecting a first image block among the plurality of image blocks as the main image block of a first window;
selecting the first window, having its major portion within the first image block, for performing a deblocking filtering on image data of the selected first window; and
performing a sample adaptive offset filtering on image data of the first image block,
wherein the perimeter of the first window does not coincide with the perimeter of the first image block.

2. The encoding method of claim 1, further comprising:
selecting a second image block among the plurality of image blocks as the main image block of a second window;
selecting the second window, having its major portion within the second image block, for performing a deblocking filtering on image data of the selected second window; and
performing a sample adaptive offset filtering on image data of the second image block,
wherein the perimeter of the second window does not coincide with the perimeter of the second image block.

3. The encoding method of claim 2, further comprising:
selecting a third image block among the plurality of image blocks as the main image block of a third window;
selecting the third window, having its major portion within the third image block, for performing a deblocking filtering on image data of the selected third window; and
performing a sample adaptive offset filtering on image data of the third image block,
wherein the perimeter of the third window does not coincide with the perimeter of the third image block.

4. The encoding method of claim 1, wherein the performing the sample adaptive offset filtering comprises:
calculating a first offset value on a basis of image data which is deblocked at a stage of performing the deblocking filtering among the image data of the first image block; and
calculating a second offset value on a basis of image data which is not deblocked at a stage of performing the deblocking filtering among the image data of the first image block.

5. The encoding method of claim 1, wherein the performing the sample adaptive offset filtering comprises:
calculating a first offset value according to the difference between current image data and original image data corresponding to the first image block and the first window;
calculating a second offset value according to the difference between current image data and original image data corresponding to the first image block and not corresponding to the first window; and
calculating a final offset value by performing a weighted calculation of the first and second offset values.

6. The encoding method of claim 5, wherein the final offset value is included in an encoding result as encoding information of the first image block.

7. The encoding method of claim 5, wherein the first offset value has a weighting of 1 and the second offset value has a weighting of 0.

8. The encoding method of claim 5, wherein the first offset value has a weighting of ½ and the second offset value has a weighting of ½.

9. The encoding method of claim 8, wherein the final offset value is calculated by reflecting a correction constant of −1.

10. The encoding method of claim 5, wherein the first offset value has a ratio of image data of the first image block to image data corresponding to the first image block and the selected window as a weighting, and
wherein the second offset value has a ratio of image data of the first image block to image data corresponding to the first image block and not corresponding to the first window as a weighting.

11. The encoding method of claim 5, wherein the first and second offset values are determined according to intensity that image data is deblocked at a stage of performing the deblocking filtering.

12. The encoding method of claim 1, wherein performing the deblocking filtering and performing the sample adaptive offset filtering are to process the plurality of image blocks with corresponding selections of a plurality of windows, in a pipeline method.

13. The encoding method of claim 1, wherein the main image block of the first window occupies more than 50% of the first window.

14. A decoding method of decoding image data a plurality of image blocks of a frame, the method comprising:
selecting a first image block among the plurality of image blocks as the main image block of a first window;
selecting the first window, having its major portion within the first image block, to perform a deblocking filtering on image data of the first window; and
performing a sample adaptive offset filtering on a basis of the first window,
wherein the perimeter of the first window does not coincide with the perimeter of the first image block.

15. The decoding method of claim 14, wherein performing the sample adaptive offset filtering is performed using offset values of the first image block and at least one image block adjacent to the first image block, and
wherein the first image block occupies more than 50% of the first window and the at least one adjacent image block includes a minor portion of the first window.

16. The decoding method of claim 15, wherein performing the sample adaptive offset filtering comprises:
compensating image data corresponding to the first window and the first image block using the offset value of the first image block; and
compensating image data corresponding to the first window and the at least one adjacent image block using the offset value of the at least one adjacent image block.

17. The decoding method of claim 14, wherein a size of the first window is depends on the location of the first image block within the frame.

18. An operating method of an image codec circuit encoding and decoding image data of a frame, the method comprising:
performing a sample adaptive offset measurement on the image data within a first window; and
performing a sample adaptive offset compensation on the image data on which the sample adaptive offset measurement is performed on a basis of a second window.

19. The operation method of claim 18, wherein the first and second windows are in different locations in the frame.

20. The operation method of claim 18, wherein the image data is divided into a plurality of image blocks in the frame,
wherein the first window corresponds to a first image block among the image blocks, and
wherein the second window does not coincide with first image block.
